(19) United States
(12) Patent Application Publication
(10) Pub. No.: US 2023/0035471 A1
(43) Pub. Date: Feb. 2, 2023

(54) ANTENNA SYSTEM AND MOBILE TERMINAL

(71) Applicant: HUIZHOU TCL MOBILE COMMUNICATION CO., LTD, Huizhou, Guangdong (CN)

(72) Inventors: Jianhua XU, Huizhou, Guangdong (CN); Fangshao ZOU, Huizhou, Guangdong (CN)

(73) Assignee: HUIZHOU TCL MOBILE COMMUNICATION CO., LTD, Huizhou, Guangdong (CN)

(21) Appl. No.: 17/758,060

(22) PCT Filed: Feb. 20, 2020
(86) PCT No.: PCT/CN2020/075930

§ 371 Date: Jun. 27, 2022

(30) Foreign Application Priority Data
Dec. 27, 2019 (CN) 201911373668.X

(51) Int. Cl. H01Q 1/50; H04B 1/00; H04B 1/04

(52) U.S. Cl. CPC H01Q 1/50; H04B 1/006; H04B 1/0475; H04B 2001/0491

(57) ABSTRACT

Embodiments of the present disclosure are directed to an antenna system and a mobile terminal. The antenna system includes a metal antenna, a radio frequency module, and an antenna tuning switch. The mobile terminal includes the antenna system mentioned above. An embodiment of the present disclosure is capable of improving the stability of sensor detection and prevent the whole machine from being in a state of power reduction for a long time, resulting in signal deterioration.

### CROSS REFERENCE TO RELATED APPLICATION

This application claims priority to Chinese Application No. 201911373668.X, filed on Dec. 27, 2019. The entire disclosure of the above application is incorporated herein by reference.

### FIELD OF THE INVENTION

The present disclosure relates to the field of communication, more particularly, to an antenna system and a mobile terminal.

### BACKGROUND

At present, a variety of wireless communication equipment has been very popular. The wireless communication equipment not only brings convenience to people, but also brings electromagnetic radiation damage to the human body. In the world, the specific absorption ratio (SAR) is usually used to measure the thermal effect of terminal radiation.

The lower the SAR value is, the less harm it will do to the human body, but the lower the radiation power will lead to signal deterioration.

The early design scheme was a specific independent proximity sensor (PS) flexible printed circuit board (FPC) antenna. The advantage of this scheme was that the sensor detection was stable, but the disadvantage was that the cost was very high and the equipment space was occupied. Later, it evolved into an antenna-sensor integrated design. The sensor circuit was connected in parallel to the radio frequency (RF) circuit. The advantage of this scheme was that the antenna was shared, and the cost was reduced. The disadvantage was that the sensor detection was unstable, and the power of the whole machine was reduced for a long time, thereby causing the signal to deteriorate.

### SUMMARY

An embodiment of the present disclosure is directed to an antenna system and a mobile terminal, which can improve the stability of sensor detection and prevent the whole machine from being in a state of power reduction for a long time, resulting in signal deterioration.

In a first aspect, an embodiment of the present disclosure is directed to an antenna system. The antenna system includes a metal antenna, a radio frequency module, an antenna tuning switch, and a sensor module. The metal antenna has a first feed point and a second feed point. The radio frequency module is connected to the first feed point. The antenna tuning switch is connected to the second feed point. The sensor module is connected between the second feed point and the antenna tuning switch.

Optionally, the antenna system further includes a first decoupling unit, connected between the sensor module and the second feed point. The first decoupling unit is used for isolating an interference of a radio frequency signal transmitted by the radio frequency module to the sensor module.

Optionally, the first decoupling unit comprises a first inductance with a first inductance value of 440 nH.

Optionally, the antenna system further includes a second decoupling unit, disposed between the second feed point and the antenna tuning switch. The second decoupling unit is used for isolating an interference of a signal transmitted by the sensor module to the antenna tuning switch.

Optionally, the second decoupling unit comprises a second inductance, connected between the antenna tuning switch and a metal ground plate, and a first capacitance, connected between the second feed point and the antenna tuning switch.

Optionally, the second inductance value is 100 nH, and the first capacitance value is 0Ω.

Optionally, the antenna tuning switch comprises a multi-channel tuning switch for switching a harmonic frequency, and an antenna tuner for adjusting an impedance matching between the radio frequency signal and the metal antenna.

Optionally, the antenna tuning switch further comprises a byte-wide peripheral interface (BPI) interface connected to a baseband chip.

Optionally, the sensor module comprises a sensor chip and a general-purpose input/output (GPIO) interface connected to the baseband chip.

In the second aspect, an embodiment of the present disclosure is also directed to a mobile terminal. The mobile terminal includes an antenna system. The antenna system includes a metal antenna, a radio frequency module, an antenna tuning switch, a first decoupling unit, a second decoupling unit, and a sensor module. The metal antenna has a first feed point and a second feed point. The radio frequency module is connected to the first feed point. The antenna tuning switch is connected to the second feed point. The sensor module is connected between the second feed point and the antenna tuning switch. The first decoupling unit is connected between the sensor module and the second feed point. The first decoupling unit is used for isolating an interference of a radio frequency signal transmitted by the radio frequency module to the sensor module. The second decoupling unit is disposed between the second feed point and the antenna tuning switch. The second decoupling unit is used for isolating an interference of a signal transmitted by the sensor module to the antenna tuning switch.

Optionally, the first decoupling unit comprises a first inductance with a first inductance value of 440 nH.

Optionally, the second decoupling unit comprises a second inductance, connected between the antenna tuning switch and a metal ground plate, and a first capacitance, connected between the second feed point and the antenna tuning switch.

Optionally, the second inductance value is 100 nH, and the first capacitance value is 0Ω.

Optionally, the antenna tuning switch comprises a multi-channel tuning switch for switching a harmonic frequency, and an antenna tuner for adjusting an impedance matching between the radio frequency signal and the metal antenna.

Optionally, the antenna tuning switch further comprises a byte-wide peripheral interface (BPI) interface connected to a baseband chip.

Optionally, the sensor module comprises a sensor chip and a general-purpose input/output (GPIO) interface connected to the baseband chip.

The antenna system includes a metal antenna, a radio frequency module, an antenna tuning switch, and a sensor module. The metal antenna has a first feed point and a second feed point. The radio frequency module is connected to the first feed point. The antenna tuning switch is connected to the second feed point. The sensor module is connected between the second feed point and the antenna tuning switch. The antenna system can improve the stability of sensor detection and prevent the whole machine from being in a state of power reduction for a long time, resulting in signal deterioration.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a first structural diagram of an antenna system according to one embodiment of the present disclosure.

FIG. 2 is a second flow diagram of the antenna system according to one embodiment of the present disclosure.

FIG. 3 is a structural diagram of a mobile terminal according to one embodiment of the present disclosure.

### DESCRIPTION OF THE EMBODIMENTS

Embodiments of the present application are illustrated in detail in the accompanying drawings, in which like or similar reference numerals refer to like or similar elements or elements having the same or similar functions throughout the specification. The embodiments described below with reference to the accompanying drawings are exemplary and are intended to be illustrative of the present application, and are not to be construed as limiting the scope of the present application.

It is understood that terminologies, such as “center,” “longitudinal,” “horizontal,” “length,” “width,” “thickness,” “upper” “lower,” “before,” “after,” “left,” “right,” “vertical,” “horizontal,” “top,” “bottom,” “inner,” “outer,” “clockwise,” and “counterclockwise,” are locations and positions regarding the figures. These terms merely facilitate and simplify descriptions of the embodiments instead of indicating or implying the device or components to be arranged on specified locations, to have specific positional structures and operations. These terms shall not be construed in an ideal or excessively formal meaning unless it is clearly defined in the present specification. In addition, the term “first”, “second” are for illustrative purposes only and are not to be construed as indicating or imposing a relative importance or implicitly indicating the number of technical features indicated. Thus, a feature that limited by “first”, “second” may expressly or implicitly, include at least one of the features. In the description of the present disclosure, the meaning of “plural” is two or more, unless otherwise specifically defined.

All of the terminologies containing one or more technical or scientific terminologies have the same meanings that persons skilled in the art understand ordinarily unless they are not defined otherwise. For example,” arrange,” “couple,” and “connect,” should be understood generally in the embodiments of the present disclosure. For example, “firmly connect,” “detachably connect,” and “integrally connect” are all possible. It is also possible that “mechanically connect,” “electrically connect,” and “mutually communicate” are used. It is also possible that “directly couple,” “indirectly couple via a medium,” and “two components mutually interact” are used.

All of the terminologies containing one or more technical or scientific terminologies have the same meanings that persons skilled in the art understand ordinarily unless they are not defined otherwise. For example, “upper” or “lower” of a first characteristic and a second characteristic may include a direct touch between the first and second characteristics. The first and second characteristics are not directly touched; instead, the first and second characteristics are touched via other characteristics between the first and second characteristics. Besides, the first characteristic arranged on/above/over the second characteristic implies that the first characteristic arranged right above/obliquely, above or merely means that the level of the first characteristic is higher than the level of the second characteristic. The first characteristic arranged under/below/beneath the second characteristic implies that the first characteristic arranged right under/obliquely under or merely means that the level of the first characteristic is lower than the level of the second characteristic.

Different methods or examples are introduced to elaborate different structures in the embodiments of the present disclosure. To simplify the method, only specific components and devices are elaborated by the present disclosure. These embodiments are truly exemplary instead of limiting the present disclosure. Identical numbers and/or letters for reference are used repeatedly in different examples for simplification and clearance. It does not imply that the relations between the methods and/or arrangement. The methods proposed by the present disclosure provide a variety of examples with a variety of processes and materials. However, persons skilled in the art understand ordinarily that the application of other processes and/or the use of other kinds of materials are possible.

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

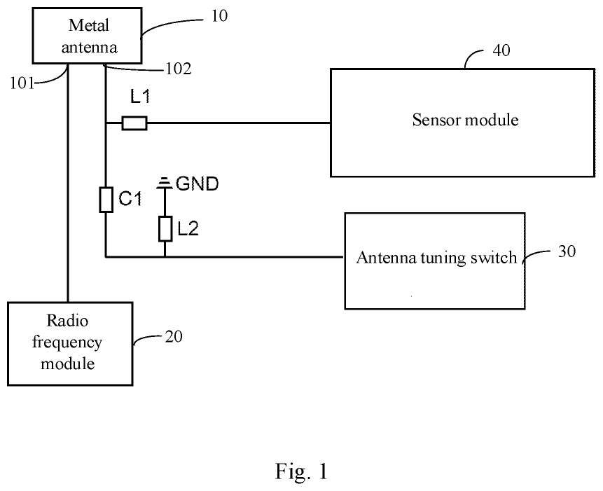

Please refer to FIG. 1, which is a first structural diagram of an antenna system according to one embodiment of the present disclosure. The antenna system comprises a metal antenna 10, a radio frequency module 20, and an antenna tuning switch 30.

The metal antenna 10 has a first feed point 101 and a second feed point 102.

The first feed point 101 is connected to the radio frequency module 20.

The second feed point 102 is connected to the antenna tuning switch 30.

A sensor module 40 is also connected in parallel between the second feed point 102 and the antenna tuning switch 30.

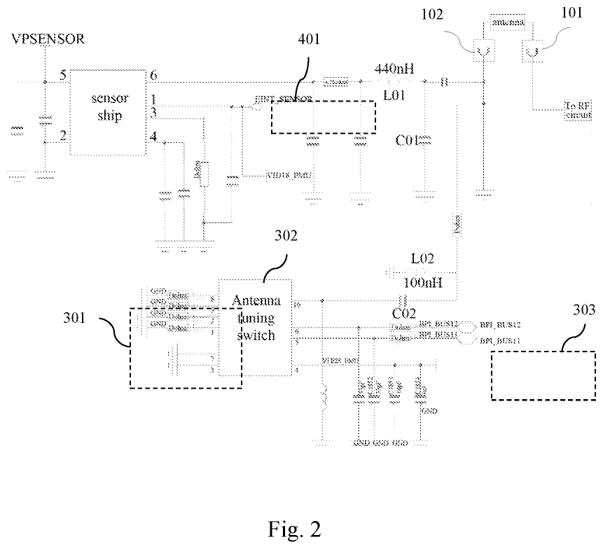

As shown in FIG. 2 illustrating a circuit structure diagram of the antenna system shown in FIG. 1. The first feed point 101 is an antenna feed point, and the second feed point 102 is an antenna coordination switch feed point. The metal antenna 10 is connected to the radio frequency module 20 and the antenna tuning switch 30 through the first feed point 101 and the second feed point 102 respectively. A sensor module 40 is connected in parallel between the second feed point 102 and the antenna tuning switch 30. The sensor module 40 and the antenna tuning switch 30 are isolated in parallel, so that the sensor module 40 and the antenna tuning switch 30 work independently without interfering with each other.

The antenna system includes a metal antenna, a radio frequency module, an antenna tuning switch, and a sensor module. The metal antenna has a first feed point and a second feed point. The radio frequency module is connected to the first feed point. The antenna tuning switch is connected to the second feed point. The antenna system provided by an embodiment of the present disclosure isolates the sensor module 40 and the antenna tuning switch 30 in parallel, so that the sensor module 40 and the antenna tuning switch 30 can work independently without interfering with each other, thereby improving the stability of sensor detection and preventing the whole machine from being in a state of power reduction for a long time, resulting in signal deterioration.

A first decoupling unit is connected in series between the sensor module 40 and the second feed point 102, and the first decoupling unit is used to isolate the interference of the radio frequency signal transmitted by the radio frequency module 20 to the sensor module 40.

Please refer to FIG. 2. The first decoupling unit may comprise a first inductance L1 (L01 in FIG. 2), which is connected in series between the sensor module 40 and the second feed point 102. The first inductance L1 is used to isolate the interference of the radio frequency signal transmitted by the radio frequency module 20 to the sensor module 40.

The first inductance L1 value is 440 nH.

A second decoupling unit is disposed between the second feed point 102 and the antenna tuning switch 30, and the second decoupling unit is used to isolate the interference of the signal transmitted by the sensor module 40 to the antenna tuning switch 30.

Please refer to FIG. 2. The second decoupling unit may comprise a second inductance L2 and a first capacitance C1 (i.e. L02 and C01 in FIG. 2), the first capacitance C1 is connected in series between the second feed point 102 and the antenna tuning switch 30, and the second inductance L2 is connected in series between the antenna tuning switch 30 and a metal ground plate.

The second inductance L2 value is 100 nH, and the first capacitance C1 value is 0Ω.

The antenna tuning switch 30 comprises a multi-channel tuning switch 301 and an antenna tuner 302, the antenna tuner 302 is used to adjust the impedance matching between the radio frequency signal and the metal antenna 10, and the multi-channel tuning switch is used to switch a harmonic frequency.

The antenna tuning switch 30 in FIG. 2 comprises a 4-way tuning switch for tuning the matching of each of the antennas.

The antenna tuning switch 30 further comprises a byte-wide peripheral interface (BPI) 303 connected to a baseband chip.

Specifically, the BPI interface 303 is used to control the operation of the antenna tuning switch 30.

The sensor module 40 comprises a sensor chip 40 and a general-purpose input/output (GPIO) interface 401 connected to the baseband chip.

The GPIO interface 401 has the function of controlling the operation of the sensor chip 40.

Furthermore, an embodiment of the present disclosure is also directed to a mobile terminal. The mobile terminal includes an antenna system. The antenna system includes a metal antenna, a radio frequency module, an antenna tuning switch, a first decoupling unit, a second decoupling unit, and a sensor module. The metal antenna has a first feed point and a second feed point. The radio frequency module is connected to the first feed point. The antenna tuning switch is connected to the second feed point. The sensor module is connected between the second feed point and the antenna tuning switch. The first decoupling unit is connected between the sensor module and the second feed point. The first decoupling unit is used for isolating an interference of a radio frequency signal transmitted by the radio frequency module to the sensor module. The second decoupling unit is disposed between the second feed point and the antenna tuning switch. The second decoupling unit is used for isolating an interference of a signal transmitted by the sensor module to the antenna tuning switch.

Optionally, the first decoupling unit comprises a first inductance with a first inductance value of 440 nH.

Optionally, the second decoupling unit comprises a second inductance, connected between the antenna tuning switch and a metal ground plate, and a first capacitance, connected between the second feed point and the antenna tuning switch.

Optionally, the second inductance value is 100 nH, and the first capacitance value is 0Ω.

Optionally, the antenna tuning switch comprises a multi-channel tuning switch for switching a harmonic frequency, and an antenna tuner for adjusting an impedance matching between the radio frequency signal and the metal antenna.

Optionally, the antenna tuning switch further comprises a byte-wide peripheral interface (BPI) interface connected to a baseband chip.

Optionally, the sensor module comprises a sensor chip and a general-purpose input/output (GPIO) interface connected to the baseband chip.

An embodiment of the present disclosure is also directed to a mobile terminal, which comprises the antenna system mentioned above.

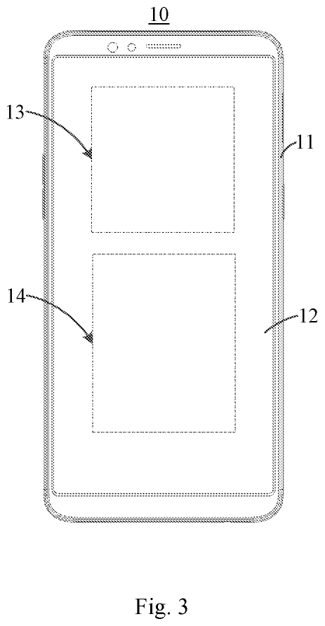

Please refer to FIG. 3, which is a structural diagram of the mobile terminal according to one embodiment of the present disclosure. The mobile terminal 10 comprises a housing 11, a display screen 12, a circuit board 13, and a battery 14.

The housing 11 forms an outer contour of the mobile terminal 10. The housing 11 may be a metal housing, such as magnesium alloy and stainless steel. The material of the housing 11 is not limited thereto, but other methods can be adopted. For example, the housing 11 may be a plastic housing, a ceramic housing, a glass housing, etc.

The display screen 12 is mounted in housing 11. The display screen 12 is electrically connected to the circuit board 13 to form a display surface of the mobile terminal 10. The display surface of the mobile terminal 10 may be provided with a non-display area. For example, at least one of a top end and a bottom end of the mobile terminal 10 may form the non-display area, that is, the mobile terminal 10 may form the non-display area with at least one of an upper portion and a lower portion of the display screen 12. The mobile terminal 10 may install a camera, a receiver, or other devices in the non-display area. It should be noted that the display surface of the mobile terminal 10 may not be provided with the non-display area, that is, the display screen 12 may be a full screen. The display screen 12 can be laid on the entire display surface of the mobile terminal 10, so that the display screen 12 can be displayed in full screen on the display surface of the mobile terminal 10.

The display screen 12 may have a regular shape, such as a rectangular structure and a rounded rectangular structure. In some embodiments, the display screen 12 may also have an irregular shape.

The display screen 12 may be one or a combination of a liquid crystal display (LCD) monitor, an organic light-emitting diode (OLED) monitor, an electronic ink display device, a plasma display panel (PDP), and a display device using other display technologies. The display screen 12 may comprise an array of touch sensors (i.e., the display screen 12 may be a touch display screen). The touch sensor may be a capacitive touch sensor formed from an array of transparent touch sensor electrodes (e.g., indium tin oxide (ITO) electrodes), or may be a touch sensor formed using other touch technologies, such as sonic touch, pressure-sensitive touch, resistive touch, and optical touch. The embodiments of the present disclosure are not limited thereto.

A cover plate covers the display screen 12, which can cover the display screen 12 to protect the display screen 12. The cover plate can be a transparent glass cover plate, so that the display screen 12 can display through the cover plate. The cover plate may be a glass cover plate made of a material such as sapphire.

After the display screen 12 is installed on the housing 11, a storage space is formed between the housing 11 and the display screen 12. The storage space can accommodate the devices of the mobile terminal 10, such as the circuit board 13 and the battery 14.

The circuit board 13 is installed in the housing 11. The circuit board 13 can be the main board of the mobile terminal 10. The circuit board 13 can be integrated with one, two, or more of the motor, microphone, speaker, headphone interface, universal serial bus (USB) interface, camera, distance sensor, ambient light sensor, receiver, processor, and other functional devices.

The circuit board 13 is fixed in the housing 11. The circuit board 13 can be screwed to the housing 11 by screws or clamped to the housing 11 by snaps. It should be noted that the specific way in which the circuit board 13 is fixed to the housing 11 in the embodiments of the present disclosure is not limited thereto, but can also be fixed in other ways, such as through a buckle and a screw at the same time.

The battery 14 is installed in the housing 11, and the battery 11 is electrically connected to the circuit board 13 to provide power to the mobile terminal 10. The housing 11 may serve as a battery cover for the battery 14. The housing 11 covers the battery 14 to protect the battery 14 and reduce damage to the battery 14 due to such as collision and falling of the mobile terminal 10.

The battery 14 may be a nickel-cadmium (Ni—Cd) battery, a lithium-ion (Li-Ion) battery, or other types of batteries. The number of batteries can be one or more. The shape of the battery can be square, strip, or other shapes, which can be set according to the internal structure of the mobile terminal 10 in practical, but the embodiments of the present disclosure are not limited thereto.

In the above-mentioned embodiments, the description of each embodiment has its own weight, and the part described in a certain embodiment can be described in the same way as other embodiments.

The embodiments of the present disclosure provides an antenna system and a mobile terminal. The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. An antenna system, comprising:
a metal antenna, having a first feed point and a second feed point;
a radio frequency module, connected to the first feed point;
an antenna tuning switch, is connected to the second feed point; and
a sensor module, connected between the second feed point and the antenna tuning switch.

2. The antenna system as claimed in claim 1, further comprising:
a first decoupling unit, connected between the sensor module and the second feed point, for isolating an interference of a radio frequency signal transmitted by the radio frequency module to the sensor module.

3. The antenna system as claimed in claim 2, wherein the first decoupling unit comprises a first inductance with a first inductance value of 440 nH.

4. The antenna system as claimed in claim 1, further comprising:
a second decoupling unit, disposed between the second feed point and the antenna tuning switch, for isolating an interference of a signal transmitted by the sensor module to the antenna tuning switch.

5. The antenna system as claimed in claim 4, wherein the second decoupling unit comprises:
a second inductance, connected between the antenna tuning switch and a metal ground plate; and
a first capacitance, connected between the second feed point and the antenna tuning switch.

6. The antenna system as claimed in claim 5, wherein the second inductance value is 100 nH, and the first capacitance value is 0Ω.

7. The antenna system as claimed in claim 2, wherein the antenna tuning switch comprises:
a multi-channel tuning switch for switching a harmonic frequency; and
an antenna tuner for adjusting an impedance matching between the radio frequency signal and the metal antenna.

8. The antenna system as claimed in claim 7, wherein the antenna tuning switch further comprises a byte-wide peripheral interface (BPI) interface connected to a baseband chip.

9. The antenna system as claimed in claim 8, wherein the sensor module comprises a sensor chip and a general-purpose input/output (GPIO) interface connected to the baseband chip.

10. A mobile terminal, comprising an antenna system, the antenna system comprising:
a metal antenna, having a first feed point and a second feed point;
a radio frequency module, connected to the first feed point;
an antenna tuning switch, is connected to the second feed point;
a sensor module, connected between the second feed point and the antenna tuning switch;
a first decoupling unit, connected between the sensor module and the second feed point, for isolating an interference of a radio frequency signal transmitted by the radio frequency module to the sensor module; and
a second decoupling unit, disposed between the second feed point and the antenna tuning switch, for isolating an interference of a signal transmitted by the sensor module to the antenna tuning switch.

11. The mobile terminal as claimed in claim 10, wherein the first decoupling unit comprises a first inductance with a first inductance value of 440 nH.

12. The mobile terminal as claimed in claim 10, wherein the second decoupling unit comprises:
a second inductance, connected between the antenna tuning switch and a metal ground plate; and
a first capacitance, connected between the second feed point and the antenna tuning switch.

13. The mobile terminal as claimed in claim 12, wherein the second inductance value is 100 nH, and the first capacitance value is 0Ω.

14. The mobile terminal as claimed in claim 10, wherein the antenna tuning switch comprises:
a multi-channel tuning switch for switching a harmonic frequency; and
an antenna tuner for adjusting an impedance matching between the radio frequency signal and the metal antenna.

15. The mobile terminal as claimed in claim 14, wherein the antenna tuning switch further comprises a byte-wide peripheral interface (BPI) interface connected to a baseband chip.

16. The mobile terminal as claimed in claim 15, wherein the sensor module comprises a sensor chip and a general-purpose input/output (GPIO) interface connected to the baseband chip.
